(19) United States
(12) Patent Application Publication
(10) Pub. No.: US 2013/0346921 A1
(43) Pub. Date: Dec. 26, 2013

(54) LIGHT FIELD LOCKSCREEN

(71) Applicant: Google Inc., Mountain View, CA (US)

(72) Inventors: Daniel Marc Gatan Shiplacoff, Los Altos, CA (US); Matias Gonzalo Duarte, Mountain View, CA (US); Michael Andrew Cleron, Menlo Park, CA (US)

(21) Appl. No.: 13/782,908

(22) Filed: Mar. 1, 2013

Related U.S. Application Data
(60) Provisional application No. 61/664,745, filed on Jun. 26, 2012.

(51) Int. Cl. G06F 3/0481

(52) U.S. Cl. CPC G06F 3/04817
USPC 715/835

(57) ABSTRACT

A method includes outputting, for display, an array of objects surrounding an icon, wherein the icon indicates a limited access state of the computing device, receiving, at the computing device when the computing device is in the limited access state, an indication of a user input received at a presence-sensitive input device, the user input to activate a plurality of objects in the array of objects surrounding the lock icon, and transitioning the computing device from the limited access state to an access state responsive to the indication of the user input.

### RELATED APPLICATION

This application claims the benefit of U.S. Provisional Application No. 61/664,745, filed Jun. 26, 2012, the entire content of which is incorporate herein by reference.

### BACKGROUND

Computing devices can perform various functions, such as executing applications stored at the computing device and displaying image content (e.g., documents, e-mails, and pictures) on a screen. Certain computing devices can include a limited access state that prevents a user from accessing applications and information stored at the computing device, thereby effectively “locking” the computing device. For example, some computing devices can enable a user to provide an input to lock the device, or can lock the device after a predetermined amount of time of inactivity of the device.

Such locking techniques can be useful to prevent unintended users from accessing applications or information stored at the computing device. For instance, the computing device can be a mobile computing device, such as a mobile phone, tablet computer, laptop computer, and the like, that can be lost or misplaced. Locking the computing device can prevent an unauthorized user, such as a user who happens to find the lost or misplaced computing device, from accessing information or applications stored at the computing device. As such, the locking techniques can provide a measure of security to ensure that information and applications stored at the computing device can only be accessed by users who know a passcode to unlock the computing device.

Such computing devices typically enable a user to provide the passcode to unlock the computing device and gain access to the applications or information stored at the computing device. If the user provides the correct passcode, the computing device unlocks providing access to the applications or information. Otherwise, the computing device remains in the locked state.

### SUMMARY

Examples according to this disclosure are directed to transitioning a computing device from a limited access state to a different access state via user interaction with a presence-sensitive display device. In one example, a method includes outputting, for display, an array of objects surrounding an icon, wherein the icon indicates a limited access state of the computing device, receiving, at the computing device when the computing device is in the limited access state, an indication of a user input received at a presence-sensitive input device, the user input to activate a plurality of objects in the array of objects surrounding the lock icon, and transitioning the computing device from the limited access state to an access state responsive to the indication of the user input.

In another example, a computing device includes one or more processors and a presence-sensitive input device. The one or more processors are operable to output, for display, an array of objects surrounding an icon, wherein the icon indicates a limited access state of the computing device, receive, at the computing device when the computing device is in the limited access state, an indication of a user input received at the presence-sensitive input device, the user input to activate a plurality of objects in the array of objects surrounding the lock icon, and transition the computing device from the limited access state to an access state responsive to the indication of the user input.

In another example, a computer-readable storage medium includes instructions that, if executed by a computing device having one or more processors operatively coupled to a presence-sensitive display, cause the computing device to perform operations including outputting, for display, an array of objects surrounding an icon, wherein the icon indicates a limited access state of the computing device, receiving, at the computing device when the computing device is in the limited access state, an indication of a user input received at a presence-sensitive input device, the user input to activate a plurality of objects in the array of objects surrounding the lock icon, and transitioning the computing device from the limited access state to an access state responsive to the indication of the user input.

The details of one or more aspects of this disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example computing device that can transition from a limited access state to a full access state.

FIG. 2 is a block diagram illustrating an example display of a computing device.

FIGS. 3A-3C is a block diagram illustrating an example display of a computing device.

FIGS. 4A-4C is a block diagram illustrating another example display of a computing device.

FIGS. 5A-5C are block diagrams illustrating three different example displays of a computing device.

FIG. 6 is a block diagram illustrating an example computing device, in accordance with one or more aspects of this disclosure.

FIG. 7 is a flow chart illustrating an example operation of a computing device to transition the computing device from a limited access to a different access state.

FIGS. 8A-9D are block diagrams illustrating a number of different example displays of a computing device.

FIG. 10 is a block diagram illustrating an example computing device that outputs graphical content for display at a remote device, in accordance with one or more techniques of the present disclosure.

### DETAILED DESCRIPTION

Examples described in this disclosure relate to techniques that can enable a computing device (e.g., a computing device including and/or operatively coupled to a touch- and/or presence-sensitive display) to receive user inputs when the computing device is in a limited access state (e.g., a “locked” state). In the limited access state, the computing device can deny access to one or more applications and information stored at the computing device. User inputs received at the computing device can designate one or more objects displayed at the presence-sensitive display as elements of a candidate passcode or credential. In some implementations, the computing device can transition from the locked state to an access/default state (e.g., an “unlocked” state) based at least in part on the user inputs.

In examples according to this disclosure, a presence-sensitive display device of a computing device outputs an icon and/or other visual indicia indicating that the computing device is in a locked or otherwise limited access state and an array of objects surrounding the lock icon. For example, a display of a mobile phone that is locked can present an icon in the center of the screen that visually indicates that the phone is in a locked state, such as an icon that looks like a padlock surrounded by a circle. In addition to a “lock icon,” in whatever particular form such an icon is displayed, the display of the mobile phone can output a visual cue that indicates to users a particular gesture can be used to unlock the phone. Examples of the unlock gesture cue will be described below.

In some implementations, the mobile phone display can also output an array of objects with which a user can interact to unlock the phone. In one example, the array of objects can be an array of dots that surround the lock icon and are arranged in one of a variety of different geometric configurations. For example, an array of dots can be arranged as a series of concentric circles that surround the padlock icon and are centered generally at a center of the icon or the circle surrounding the icon. This array of dots that form the series of concentric shapes (e.g., circles and/or other closed shapes such as ellipses, ovals, rectangles or squares, or irregular closed shapes) radiating outward from the lock icon can be referred to as a “light field,” as the shapes can appear on the display as an array of point light sources forming a field around the centrally-located lock icon. In an example according to this disclosure, a computing device may be configured to transition from a limited access state to a access state responsive to detecting a user input corresponding to a swipe across the touch-sensitive display of the computing device along a path beginning near the padlock icon, across the light field, and ending at the periphery of the light field, e.g., at the circle farthest from the icon.

The mobile phone (or other computing device including or coupled to a touch-sensitive display) can also be configured to provide visual feedback to the user as the user swipes across the touch-sensitive display of the phone. In such examples, the mobile phone can optionally not alter the output of the touch-sensitive display to cause the lock icon to appear to be dragged across the display along with the user swipe. In one example, however, the mobile phone can be configured to alter the appearance of the array of dots arranged as concentric circles surrounding the padlock icon to indicate activation of one or more of the dots by the user. For example, without any tactile input from a user, the touch-sensitive display of the mobile phone can generate the array of dots as completely transparent such that the dots are not visible to a user on the display of the mobile phone. Thus, while the display of the mobile phone has generated and output the array of dots arranged as concentric circles such that they are objects on the display that can be activated by a user, the dots are not visible until some tactile input is received from a user at the touch-sensitive display. Upon activation of any of the dots, e.g., as the user swipes across the touch-sensitive display, the touch-sensitive display of the mobile phone can increase the opacity of the activated dot(s) and neighboring dots based on the proximity of the user input such that the affected dots appear visually to the user on the display in conjunction with the user input and then again disappear after the user, e.g., swipes past each dot on a path radially out from the lock icon.

In another example, without any tactile input from a user, the touch-sensitive display of the mobile phone can present the array of dots arranged as concentric circles in a faded or light-colored appearance such that the dots are relatively visually deemphasized relative to other objects presented on the display like the padlock icon. However, upon activation of any of the dots, e.g., as the user swipes across the touch-sensitive display, the touch-sensitive display of the mobile phone can present the activated dot(s) and neighboring dots in a non-faded or darker colored appearance such that the dots are visually emphasized relative to the other non-activated dots in the array surrounding the padlock icon.

In another example, sets of dots in the array of dots are associated with one another such that user interaction with one dot in a set causes a visual response from all of the dots in the set. For example, all the dots arranged in each concentric circle can be associated with one another such that user interaction with one dot of one of the circles causes a visual response from all of the dots in the circle. For example, without any tactile input from a user, the touch-sensitive display of the mobile phone can present the array of dots arranged as concentric circles in a faded or light-colored appearance such that the dots are relatively visually deemphasized relative to other objects presented on the display like the padlock icon. However, upon activation of any of dot of one of the circles, e.g., as the user swipes across the touch-sensitive display, the touch-sensitive display of the mobile phone can present all of the dots of the circle (and, in some cases, the dots of neighboring circles) in a non-faded or darker colored appearance such that the dots of the circles are visually emphasized relative to the other non-activated dots of other circles in the array surrounding the padlock icon. The visual effect of such an example as a user swipes across the touch-sensitive display of the mobile phone along a path beginning at the padlock icon and ending at the surrounding circle farthest from the icon can be the appearance of a “wave” of visual emphasis that radiates out from the innermost to the outermost circle surrounding the padlock icon.

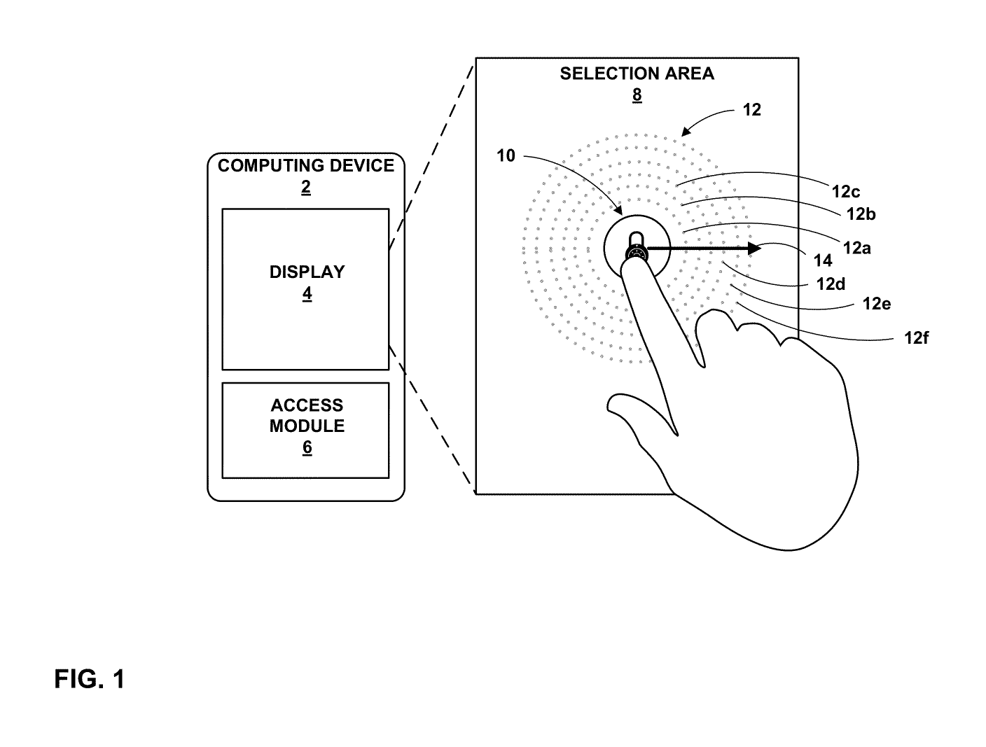

FIG. 1 is a block diagram illustrating an example computing device that can transition from a limited access state to an access state, in accordance with one or more aspects of this disclosure. For example, computing device 2 can transition from a locked state in which access to applications and information stored on computing device 2 is denied to a full access state in which device 2 is unlocked and user is free to access applications and data and other information stored on the device. As illustrated in FIG. 1, computing device 2 includes display 4 and access module 6. Examples of computing device 2 include, but are not limited to, portable or mobile devices such as cellular phones, personal digital assistants (PDAs), tablet computers, laptop computers, portable gaming devices, portable media players, e-book readers, as well as non-portable devices such as desktop computers including or connected to a touch-sensitive display device.

Display 4 can be a liquid crystal display (LCD), e-ink, organic light emitting diode (OLED), or other display. Display 4 can present the content of computing device 2 to a user. For example, display 4 can display the output of applications executed on one or more processors of computing device 2, confirmation messages, indications, or other functions that can need to be presented to a user. In some examples, display 4 can provide some or all of the functionality of a user interface of computing device 2.

In examples according to this disclosure, display 4 can be a presence-sensitive display like, e.g., a touch-sensitive or proximity sensitive display device that is configured to facilitate user interaction with computing device 2. For example, display 4 can present a user with various functions and applications of computing device 2 like an address book stored on the device, which includes a number of contacts. In another example, display 4 can present the user with a menu of options related to the function and operation of computing device 2, including, e.g. device settings such as ring tones and phone modes, e.g. silent, normal, meeting, and other configurable settings for a phone in examples in which computing device 2 is a mobile phone. In examples according to this disclosure, display 4 presents users with a visual indication that computing device 2 is in a limited access or locked state and a mechanism by which users can transition from the locked state to a full access state.

In the example of FIG. 1, computing device 2 is in a limited access state (e.g., a locked state) configured to deny access to one or more applications stored at computing device 2. Access module 6, executing at one or more processors of computing device 2, can cause display 4 to display lock icon 10 indicating computing device 2 is in a limited access state configured to deny access to one or more applications executable by computing device 2. Additionally, access module 6, executing at one or more processors of computing device 2, can cause display 4 to generate an array of objects 12 surrounding the lock icon at activation area 8 of display 4. As will be described in more detail below, objects 12 surrounding the lock icon may be generated at display 4 such that objects 12 are not visually detectable in the absence of user input at display 4. Activation area 8 can be an area of display 4 designated to display objects that a user can interact with (e.g., activate, select, etc.) to transition computing device 2 from the limited access state to a full access state.

As illustrated in FIG. 1, access module 6 causes display 4 to display lock icon 10, which includes a graphical representation of a combination padlock surrounded by a circle. Access module 6 also causes display 4 to generate the array of objects 12, which surround lock icon 10. In the example of FIG. 1, objects 12 includes an array of dots that are arranged as a series of concentric circles 12a-12f radiating outward from the center of lock icon 10 in order of increasing diameter of each circle in the series of circles. In other examples according to this disclosure, however, the objects surrounding a lock icon can include an array of dots, or other objects, arranged as closed shapes other than circles, including, e.g., ellipses, ovals, rectangles, squares, or other polygons, or irregular closed shapes.

In some examples, access module 6 can configure each dot in each circle in the series of concentric circles 12a-12f as one of the objects in the array of objects 12 output at display 4. The array of dots that form the series of concentric circles 12a-12f radiating outward from lock icon can be referred to as a “light field,” as they can appear on display 4 as an array of point light sources forming a field around the centrally located padlock icon.

As illustrated in FIG. 1, a user can provide a gesture at display 4 (e.g., a touch-sensitive display) to cause computing device 2 to activate some of the dots in the array of objects 12 and thereby transition computing device 2 from a locked limited access state to a full access state. In the example of FIG. 1, the user gesture is a continuous swipe gesture beginning at lock icon 10 and ending at or near one or more dots arranged as circle 12f that is arranged farthest away from lock icon 10 among the series of concentric circles 12a-12f. The path of swipe gesture is illustrated in the example of FIG. 1 as swipe path arrow 14. In the example of FIG. 1, swipe path arrow 14 illustrates the straight-line horizontal path of the swipe gesture of a user employed to unlock computing device 12. In examples according to this disclosure, provided the user begins the swipe gesture at the correct target starting location, e.g., somewhere within the circle immediately surrounding padlock icon 10, and ends the continuous swipe at the correct target ending location or locations, e.g., at or beyond the last circle 12f in the series of concentric circles 12a-12f, access module 6 can be configured to transition computing device 2 from a locked limited access state to a full access state and the user can begin using various functions of computing device 2.

It should be noted that although the examples described in this disclosure illustrate a swipe gesture employing one finger of a user's hand, other gestures can also be employed to unlock a computing device. For example, a multi-finger swipe gesture can be employed to unlock computing device 2. In another example, a non-continuous gesture can be employed including taping lock icon 10 and then tapping or swiping through one or more of the dots in the array of objects 12. For example, the user can tap lock icon 10 and then tap a dot(s) in each of the concentric circles 12a-12f in order from closest to farthest from the center of icon 10. Additionally, in one example, concentric circles 12a-12f (or other closed shapes) surrounding lock icon 10 can be ordered, e.g. in a predetermined order of numbers or letters and a user can unlock computing device 2 by tapping lock icon 10 to initiate the process and then tapping a particular order of dot(s) in circles 12a-12f. Such an unlock process is analogous to unlocking a combination padlock, in which the user taps lock icon 10 and then must tap a dot or dots in a number of circles 12a-12f in a predetermined order or in which the user taps lock icon 10 and then must swipe to through a dot or dots in each of a number of circles 12a-12f in a predetermined order as part of a continuous swipe gesture.

The dots of circles 12a-12f are illustrated in FIG. 1 as partially transparent and therefore visually detectable. However, as noted above, in some examples, display 4 may generate the dots of circles 12a-12f as completely transparent until an indication of user input is received at display 4 to activate one or more of the dots. For example, without any tactile input from a user, display 4 of device 2 can generate the array of dots arranged as circles 12a-12f as completely transparent such that the dots are not visible to a user on display 4 of device 2. Thus, while display 4 has generated and output the array of dots arranged as concentric circles 12a-12f such that they are objects 12 on display 4 that can be activated (e.g., selected) by a user, the dots are not visible until some tactile input is received from a user at display 4. Upon activation (e.g., selection) of any of the dots, e.g., as the user swipes across presence-sensitive display 4, display 4 of device 2 can increase the opacity of the activated dot(s) and neighboring dots based on the proximity of the user input such that the affected dots appear visually to the user on display 4 in conjunction with the user input and then again disappear after the user, e.g., swipes past each dot on a path radially out from lock icon 10.

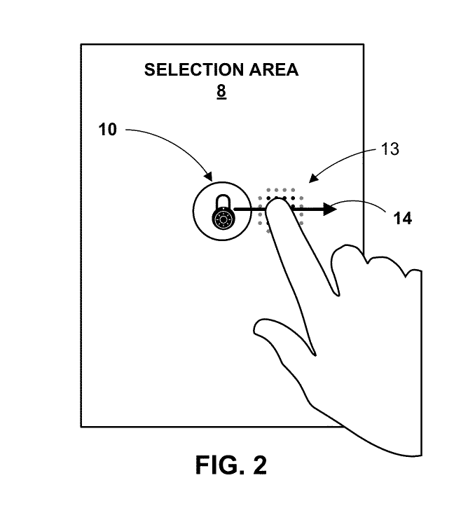

The example process by which a user can unlock computing device 2 including display 4 and access module 6 shown in FIG. 1 is illustrated in further detail with reference to the example of FIG. 2. However, in the example of FIG. 2, only dots 13 that correspond to indications of user input received at display 4 are shown and the remaining dots that make up the array of dots surrounding lock icon 10 are not shown. In this example, without any tactile input from a user, display 4 of device 2 generates the array of dots arranged as circles 12a-12f as completely transparent such that the dots are not visible to a user on display 4 of device 2.

In the example of FIG. 2, the user continues the straight line horizontal swipe gesture begun in FIG. 1 to unlock computing device 2. As illustrated by swipe path arrow 14 shown in FIG. 2, the swipe gesture employed by the user begins at lock icon 10 and ends at or beyond the dot(s) arranged farthest away from lock icon 10 among the dots arranged as the series of concentric circles 12a-12f making up objects 12. After the user begins the swipe gesture by touching display 4 at or near the padlock graphic of lock icon 10, as shown in FIG. 1, the user continuously drags their fingertip horizontally across display 4 radially outward from lock icon 10 across one or more dots in each circle in the series of concentric circles 12a-12f.

In FIG. 2, the user has continued the swipe gesture beyond lock icon 10 and an indication of user input at display 4 is received radially outward from the circle surrounding icon 10. Access module 6, in response to the user input, causes display 4 to alter the appearance of dots 13 such that the dots at or near the user input at display 4 are no longer completely transparent. Thus, upon receiving the user input in FIG. 2, e.g., as the user swipes across presence-sensitive display 4 along swipe path 14, access module 6 can cause display 4 of device 2 to increase the opacity of activated (e.g., selected) and neighboring dots 13 based on the proximity of the user input such that the affected dots appear visually to the user on display 4 in conjunction with the user input and then again disappear after the user, e.g., swipes past each dot on a path radially out from lock icon 10. In one example, the dots that are at a location on display 4 corresponding to a point or region at which the user input is received at display 4 can be visually altered from completely transparent to completely opaque, while neighboring dots that are not at the point or region of user input but are within a threshold distance can be visually altered from completely transparent to partially transparent. In one example, the degree of transparency of dots 13 is determined as a function of the distance of each dot from the point or region of user input received at display 4.

After the user executes a continuous horizontal swipe gesture from lock icon 10 to or near one or more dots at a target ending location on display 4, e.g. one or more dots arranged in the last circle 12f in the series of concentric circles 12a-12f, access module 6 can transition computing device 2 from a locked limited access state to a full access state. Additionally, access module 6 can successively can cause display 4 to increase the opacity of dots arranged as concentric circles 12a-12f based on the proximity of the user input to the dots such that the affected dots appear visually to the user on display 4 in conjunction with the user input and then again disappear after the user, e.g., swipes past each dot on a path radially out from lock icon 10.

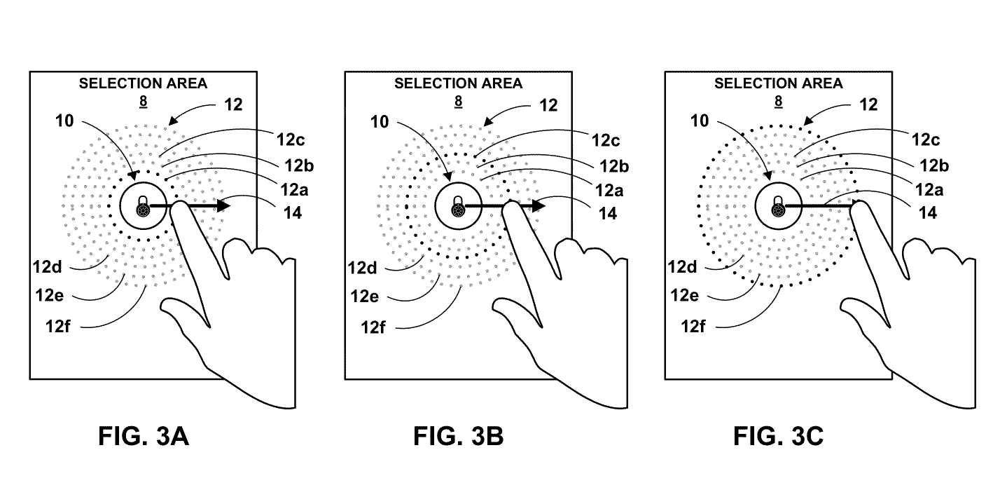

Another example process by which a user can unlock computing device 2 and access module 6 can cause display 4 to provide visual feedback in response to user input from the user to unlock the device is illustrated in FIGS. 3A-3C. In the example of FIGS. 3A-3C, the user continues the straight line horizontal swipe gesture begun in FIG. 1 to unlock computing device 2. As illustrated by swipe path arrow 14, the swipe gesture employed by the user begins at lock icon 10 and ends at or beyond the dot(s) arranged farthest away from lock icon 10 among the dots arranged as the series of concentric circles 12a-12f making up objects 12. After the user begins the swipe gesture by touching display 4 at or near the padlock graphic of lock icon 10, as shown in FIG. 1, the user continuously drags their fingertip horizontally across display 4 radially outward from lock icon 10 across one or more dots in each circle in the series of concentric circles 12a-12f.

In the example of FIGS. 3A-3C, sets of objects displayed at display 4 are associated with one another such that user interaction with one object in a set causes a visual response from all of the dots in the set. In this example, all the dots arranged in each concentric circle of circles 12a-12f are associated with one another such that user interaction with one dot of one of circles 12a-12f causes a visual response from all of the dots in the circle.

In FIG. 3A, the user has continued the swipe gesture started in FIG. 1 at lock icon 10 along swipe path 14. As noted above, access module 6 or another component of computing device 2 can be configured to cause display 4 to provide visual feedback to the user as the user swipes across display 4 to unlock computing device 2. In examples according to this disclosure, access module 6 does not alter the output of display 4 to cause the padlock of lock icon 10 to be dragged across activation area 8 of display 4 along with the user swipe. In one example, however, access module 6 is configured to cause display 4 to alter the visual appearance of the dots arranged as circles 12a-12f surrounding lock icon 10 to indicate activation by the user.

For example, without any tactile input from a user activating one or more of the dots arranged as circles 12a-12f, display 4 of computing device 2 can generate the array of dots 12 arranged as concentric circles 12a-12f in a partially transparent, faded or light-colored appearance such that the circles are relatively visually deemphasized relative to other objects presented at display 4 like icon 10. However, upon activation of any of the dots in the circles, e.g., as the user swipes across display 4, display 4 can present activated dot(s) and neighboring dots or an entire circle in a non-faded or darker colored appearance such that the activated circle is visually emphasized relative to the other non-activated circles surrounding lock icon 10. For example, as illustrated in FIG. 3A, as the user swipes across display 4, access module 6 causes display 4 to present circle 12a corresponding to dot or dots activated by the user input in a non-faded or darker colored appearance such that entire circle 12a is visually emphasized relative to the other non-activated circles 12b-12f surrounding lock icon 10.

The user swipe gesture continues from FIGS. 1 and 3A to FIGS. 3B and 3C. In FIG. 3B, the user has continued the swipe gesture along swipe path 14 and has reached the third circle 12c in the series of concentric circles 12a-12f. As the user swipes across display 4, access module 6 causes display 4 to present activated circle 12c in a non-faded or darker colored appearance such that activated circle 12c is visually emphasized relative to the other non-activated circles 12a, 12b and 12d-12f surrounding lock icon 10. In FIG. 3C, the user has continued the swipe gesture along swipe path 14 and has reached the last circle 12f in the series of concentric circles 12a-12f. As the user swipes across display 4, access module 6 causes display 4 to present activated circle 12f in a non-faded or darker colored appearance such that activated circle 12f is visually emphasized relative to the other non-activated circles 12a-12e surrounding lock icon 10. The visual effect of the user swiping across display 4 of computing device 2 along swipe path 14 in the example of FIGS. 1 and 3A-3C beginning at lock icon 10 and ending at circle 12f farthest from icon 10 can be the appearance of a “wave” of visual emphasis that radiates out from the innermost to the outermost of the series of circles 12a-12f surrounding icon 10.

After the user executes the continuous horizontal swipe gesture illustrated in FIGS. 1 and 3A-3C, beginning near lock icon 10 and ending at or beyond the last circle 12f in the series of concentric circles 12a-12f, access module 6 can transition computing device 2 from a locked limited access state to a full access state. The user of computing device 2 can then begin using various functions of the device.

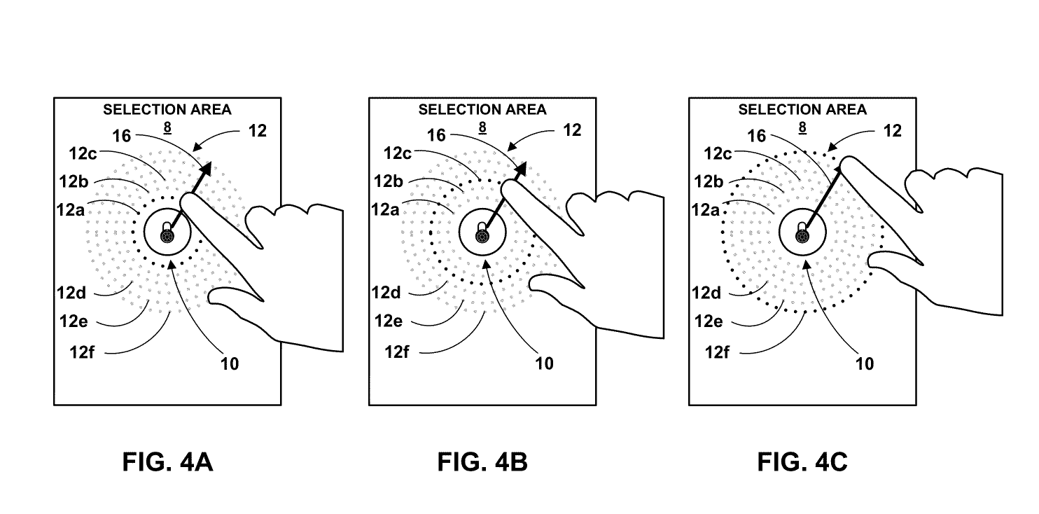

Although the example of FIGS. 1-3C illustrates a horizontal swipe gesture employed to unlock computing device 2, in other examples according to this disclosure, gestures in different directions can be employed. For example, FIGS. 4A-4C illustrate another example similar to the example of FIGS. 3A-3C, except swipe path 16 employed in FIGS. 4A-4C is not horizontal, but, instead, moves from at or near the padlock of lock icon 10 up and to the right along a diagonal trajectory across the series of concentric circles 12a-12f. Any number of other different direction swipe gestures can be employed in examples according to this disclosure. For example, the horizontal swipe gesture illustrated in the example of FIGS. 1-3C could be reversed to go from the center of lock icon 10 to the left instead of to the right. Additionally, in one example, a vertical swipe gesture beginning near lock icon 10 and proceeding straight up or down and ending at or beyond the last circle 12f in the series of concentric circles 12a-12f can be employed to unlock computing device 2.

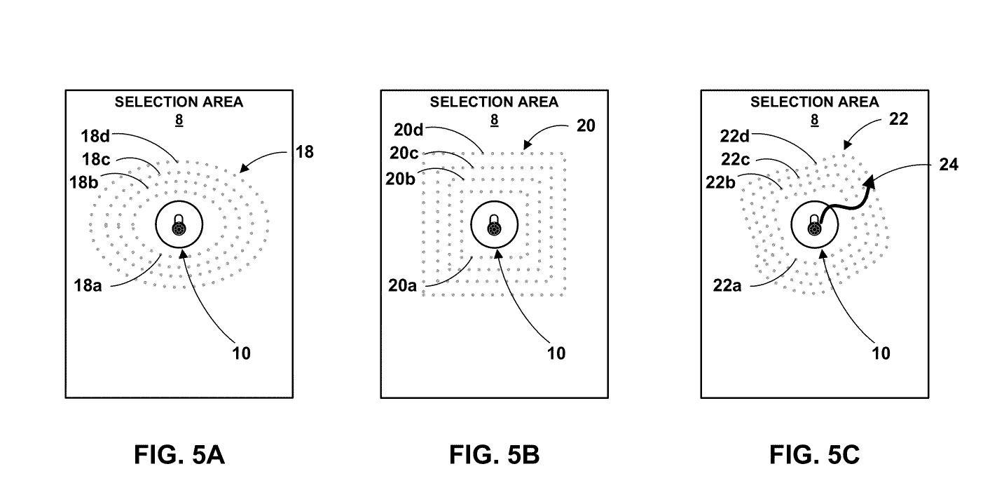

As noted above, although objects 12 of FIGS. 1-4C include an array of dots arranged as series of concentric circles 12a-12e radiating outward from the center of lock icon 10, in other examples according to this disclosure, the objects surrounding a lock icon can be an array of dots or other objects arranged as closed shapes other than circles, including, e.g., ellipses, ovals, rectangles, squares, or other polygons, or irregular closed shapes. For example, FIG. 5A illustrates another example of activation area 8 of display 4, in which access module 6 of computing device 2 causes display 4 to output lock icon 10 and an array of objects 18. The array of objects 18 includes an array of dots arranged as a series of ellipses 18a-18d radiating outward from the center of lock icon 10. In another example illustrated in FIG. 5B, access module 6 of computing device 2 causes display 4 to output lock icon 10 and an array of objects 20. The array of objects 20 includes an array of dots arranged as a series of squares 20a-20d radiating outward from the center of lock icon 10. In another example illustrated in FIG. 5C, access module 6 of computing device 2 causes display 4 to output lock icon 10 and an array of objects 22. The array of objects 22 includes an array of dots arranged as a series of irregular closed shapes 22a-22d radiating outward from the center of lock icon 10. The example of FIG. 5C also illustrates that not only closed shapes 22a-22d surrounding lock icon 10 can be irregular, but that swipe path 24 along which a user swipe gesture can be executed to transition device 2 from one access state to another can also be a curved irregular path instead of straight line paths 14 and 16 employed in the examples of FIGS. 1-4C.

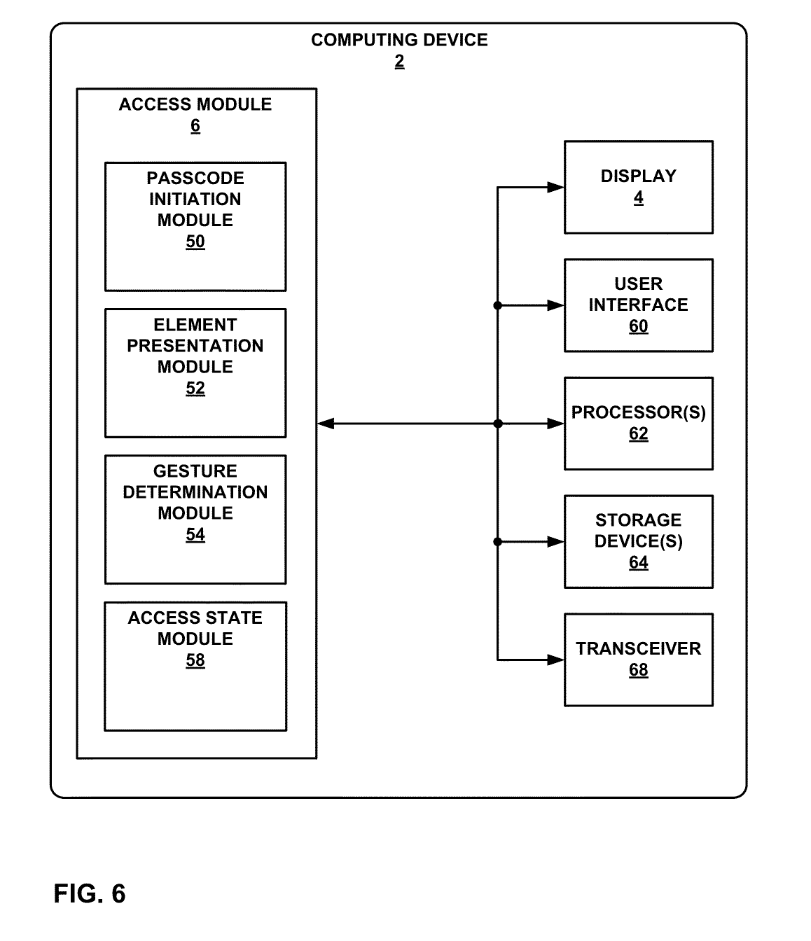

FIG. 6 is a block diagram illustrating an example configuration of computing device 2. As illustrated in FIG. 6, computing device 2 can include access module 6, display 4, user interface 60, one or more processors 62, one or more storage devices 64, and transceiver 68. Access module 6 can include access initiation module 50, element presentation module 52, gesture determination module 54, and access state module 58.

In general, the modules of access module 6 are presented separately for ease of description and illustration. However, such illustration and description should not be construed to imply that these modules of access module 6 are necessarily separately implemented, but can be in some examples. For instance, one or more of the modules of access module 6 can be formed in a common hardware unit. In some instances, one or more of the modules of access module 6 can be software and/or firmware units that are executed on one or more processors 62. In this example, one or more processor 62 can execute access module 6. In yet other examples, some of the modules with access module 6 can be implemented as one or more hardware units, and the others can be implemented as software executing on one or more processors 62. Additionally, in other examples, the functions attributed to access module 6 can be distributed among a different number of modules than that illustrated in the example of FIG. 6. For example, the functions of passcode initiation module 50 and access state module 58 can be combined into a single module of access module 6 in other examples according to this disclosure.

As discussed above, display 4 can present the content of computing device 2 to a user. In addition, in some examples, display 4 can provide some or all of the functionality of a user interface of computing device 2. For example, display 4 can be a touch-sensitive display that can allow a user to provide user gestures such as touch gestures, motion gestures, or other gestures. In certain examples, display 4 can be operatively coupled to computing device 2, but can be physically remote from computing device 2. For instance, display 4 can be a separate display that is electrically or communicatively coupled to computing device 2. As an example, computing device 2 can be a desktop computer and display 4 can be part of a tablet computer that is communicatively coupled to computing device 2, such as by a universal serial bus (USB) connection or other connection to enable communications between display 4 and computing device 2.

User interface 60 can allow a user of computing device 2 to interact with computing device 2. Examples of user interface 2 can include, but are not limited to, a keypad embedded on computing device 2, a keyboard, a mouse, a roller ball, buttons, or other devices that allow a user to interact with computing device 2. In some examples, computing device 2 may not include a separate user interface 60, and the user can interact with computing device 2 completely via display 4 (e.g., by providing various user gestures). In some examples, the user can interact with computing device 2 with user interface 60 or display 4.

Processors 62 can include any one or more of a microprocessor, a controller, a digital signal processor (DSP), an application specific integrated circuit (ASIC), a field-programmable gate array (FPGA), or equivalent discrete or integrated logic circuitry. Processors 62 can be configured to implement functionality and/or process instructions for execution within computing device 2. For example, processors 62 can be capable of processing instructions stored at one or more storage devices 64. In some examples, logic represented by access module 6 and the modules thereof can be executed by processors 62.

Storage devices 64 can include any volatile, non-volatile, magnetic, optical, or electrical media, such as a hard drive, random access memory (RAM), read-only memory (ROM), non-volatile RAM (NVRAM), electrically-erasable programmable ROM (EEPROM), flash memory, or any other digital media. Storage devices 64 can, in some examples, be considered as a non-transitory storage medium. In certain examples, storage devices 64 can be considered as a tangible storage medium. The terms “non-transitory” and “tangible” can indicate that the storage medium is not embodied in a carrier wave or a propagated signal. However, the term “non-transitory” should not be interpreted to mean that storage devices 64 are non-movable. As one example, storage devices 64 can be removed from computing device 2, and moved to another device. As another example, a storage device, substantially similar to storage devices 64, can be inserted into computing device 2. Additionally, a non-transitory storage medium can store data that can, over relatively short periods of time, change (e.g., in RAM).

In some examples, storage devices 64 can store instructions that cause processors 62, access module 6, access initiation module 50, element presentation module 52, gesture determination module 54, and access state module 58 to perform various functions ascribed to processors 62, access module 6, access initiation module 50, element presentation module 52, gesture determination module 54, and access state module 58. Storage devices 64 can be considered as a computer-readable storage media comprising instructions that cause processors 62, access module 6, access initiation module 50, element presentation module 52, gesture determination module 54, and access state module 58 to perform various functions.

Transceiver 68 can be configured to transmit data to and receive data from one or more remote devices, such as one or more server devices remote from computing device 2, or other devices. Transceiver 68 can support wireless or wired communication, and can include appropriate hardware and software to provide wireless or wired communication. For example, transceiver 68 can include one or more of an antenna, modulators, demodulators, amplifiers, and other circuitry to effectuate communication between computing device 2 and one or more remote devices.

Computing device 2 can include additional components not shown in FIG. 6. For example, computing device 2 can include a battery to provide power to the components of computing device 2. Similarly, the components of computing device 2 may not be necessary in every example of computing device 2. For instance, in certain examples computing device 2 may not include transceiver 68.

Access initiation module 50 can output a graphical user interface (GUI) at display 4 when computing device 2 is in a full access state (e.g., an unlocked state) to enable a user to configure a predetermined gesture that authorizes computing device 2 to transition computing device 2 from a limited access state (e.g., a locked state) to the full access state when properly entered by the user. For example, access initiation module 50 can allow the user to prescribe the path along which a swipe gesture beginning at or near a lock icon and ending at the closed shape in a series of closed shapes that is arranged farthest away from the lock icon is executed. For example, access initiation module 50 can enable the user of computing device 2 to specify the direction of a straight swipe path like horizontal path 14 of FIGS. 1-3C and diagonal path 16 of FIGS. 4A-4C by tracing the path on display 4. In another example, access initiation module 50 can enable the user to define a curved or otherwise irregular path like swipe path 24 of FIG. 5C by tracing the path on display 4. In another example, access initiation module 50 can enable the user to activate the format of the array of objects surrounding the lock icon presented at display 4, including, e.g., prescribing the size and spacing of the dots making up the array of objects, the shape of the series of closed shapes radiating outward from the lock icon into which the dots or other objects are arranged and the format of each of the closed shapes, e.g., the color in which the dots or other objects are displayed at display 4.

Element presentation module 52 can cause display 4 to display a lock icon indicating computing device 2 is in a limited access state configured to deny access to one or more applications executable by computing device 2 and an array of objects surrounding the lock icon at activation area 8 of display 4. In one example, element presentation module 52 causes display 4 to display lock icon 10, which includes a graphical representation of a combination padlock surrounded by a circle. Element presentation module 52 also causes display 4 to generate, and, in some cases, display an array of dots or other objects arranged as a series of concentric circles 12a-12e radiating outward from the center of lock icon 10 in order of increasing diameter of each circle in the series of circles. In other examples according to this disclosure, however, element presentation module 52 causes display 4 to generate and, in some cases, display objects surrounding a lock icon arranged in other non-circular closed shapes, including, e.g., ellipses, ovals, rectangles, squares, or other polygons, or irregular closed shapes.

Element presentation module 52 can cause display 4 to display the array of objects surrounding lock icon in a variety of formats, including, e.g., causing display 4 to display the closed shapes radiating outward from icon 10 in a number of different colors and/or levels of transparency/opacity. Additionally, element presentation module 52 can cause display 4 to alter the appearance of objects presented on the display depending on user interaction with the objects. For example, element presentation module 52 can cause display 4 to present the array of dots arranged as concentric circles 12a-12f in a faded or light-colored appearance such that the array of objects are relatively visually deemphasized relative to other objects presented on display 4 like icon 10 when gesture determination module is not detecting any indications of user input activating a portion of one or more of circles 12a-12f. However, upon activation of any of the dots in one of the circles, element presentation module 52 can cause display 4 to present a activated circle in a non-faded or darker colored appearance such that the activated circle is visually emphasized relative to the other non-activated circles surrounding lock icon 10.

In another example, element presentation module 52 can cause display 4 to generate the array of dots arranged as circles 12a-12f as completely transparent such that the dots and circles are not visible on the display. However, upon activation of any of circles 12a-12f, e.g., as the user swipes across the touch-sensitive display, element presentation module 52 can cause touch-sensitive display 4 to increase the opacity of the dots activated by the user as well as neighboring dots based on the proximity of the user input to each dot such that the affected dots appear visually to the user on the display in conjunction with the user input and then again disappear after the user, e.g., swipes past each circle radiating out from lock icon 10 along swipe path 14.

As noted above, in some examples according to this disclosure sets of objects displayed at display 4 can be associated with one another such that user interaction with one object in a set causes a visual response from all of the dots in the set. For example, all the dots arranged in each concentric circle of circles 12a-12f can be associated with one another such that user interaction with one dot of one of circles 12a-12f causes a visual response from all of the dots in the circle. For example, without any tactile input from a user, display 4 of device 2 can present the array of dots arranged as concentric circles 12a-12f as completely transparent such that the dots are not visually detectable at display 4. However, upon activation of any dot of one of the circles, e.g., as the user swipes across the touch-sensitive display, display 4 can alter the appearance of all of the dots of the circle (and, in some cases, the dots of neighboring circles) such that the circle(s) are only partially transparent or completely opaque and therefore visually detectable at display 4.

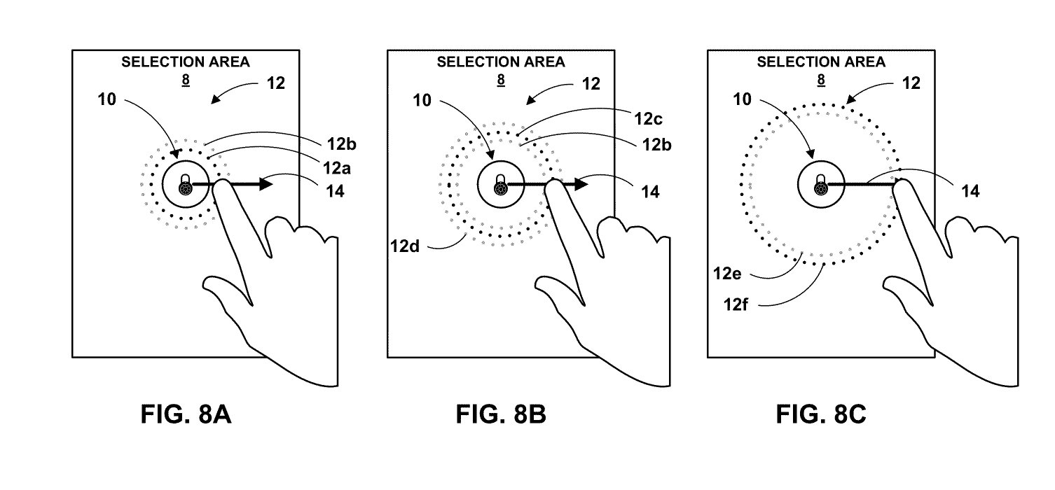

An example of the visual appearance of the foregoing examples is illustrated in FIGS. 8A-8C. In the example of FIGS. 8A-8C, as the user swipes along swipe path 14 across touch-sensitive display 4, element presentation module 52 causes display 4 to increase the opacity of some of circles 12a-12f depending on the proximity of each circle to the current location of the user's finger on display 4. In FIG. 8A, as the user begins the swipe out from lock icon 10, element presentation module 52 causes display 4 to increase the opacity of circle 12a and to increase the opacity, to a lesser degree, of circle 12b. The progression of the user swipe along swipe path 14 and the corresponding visual response of display 4 caused by element presentation module 52 proceeds in a similar manner in FIGS. 8B and 8C.

Element presentation module 52 can vary the opacity of the dots that make up circles 12a-12f or other objects in an array of objects based on the proximity of the dots to the user input received at display 4 based on a number of different parameters. For example, the opacity can increase when the user input is closer to the location of the dots on display 4 and can gradually decrease for dots further from the input location until, past a threshold distance, element presentation module 52 generates the dots as completely transparent. Other parameters that can be used by element presentation module 52 as a basis to vary the opacity of the dots that make up circles 12a-12f or other objects in an array of objects include, e.g., the duration of the user input gesture, the speed of the gesture, the distance of a particular fixed location, e.g. from the center of circles 12a-12f and lock icon 10, as well as the pressure exerted by the user on touch-sensitive display 4.

The manner by which element presentation module 52 causes display to generate and display the array of objects 12 surrounding lock icon 10, including the array of dots arranged as circles 12a-12f can vary across different examples according to this disclosure. In one example, element presentation module 52 can calculate a grid of dots to be generated and, in some examples, displayed at display 4. The grid of dots can correspond to the plurality of dots making up concentric circles 12a-12f radiating out from lock icon 10. In one example, there are a fixed number of dots on inner circle 12a (sometimes referred to below as “INNER_POINTS”), which, in one example, can be 8 dots. In one example, element presentation module 52 calculates the grid of dots one time, e.g. when computing device 2 is powered on, and then reuses the grid unmodified each time it is appropriate depending on the operational state of computing device 2.

In one example, element presentation module 52 can compute the arc length between dots on inner circle 12a and reuse that spacing to compute the distance between each dot for each successive circle 12b-12f radiating out from lock icon 10. In one example, the arc length between dots on inner circle 12a can also be employed as the distance between each of circles 12a-12f, but other spacing values can also be employed.

In one example, the size of each of the dots making up the grid of dots that form concentric circles 12a-12f can be varied as a function of the distance of the dot from the center of circles 12a-12f and lock icon 10. For example, the radius of a given dot can be varied as a function of “R,” where r is equal to the distance from the dot to a common center of circles 12a-12f. In one example, the radius of a given dot, “r,” can vary between two fixed values that are linearly interpolated based on the radius, “R.”

What follows is computer code from an example algorithm that can be employed by element presentation module 52 to compute a grid of dots. The arguments innerRadius and outerRadius are typically device-independent values (always the same distance apart on the screen—regardless of screen size).

```
public void makePointCloud(float innerRadius, float outerRadius) {
    if (innerRadius == 0) {
      Log.w(TAG, “Must specify an inner radius”);
      return;
    }
    mOuterRadius = outerRadius;
    mPointCloud.clear( );
    final float pointAreaRadius = (outerRadius − innerRadius);
    final float ds = (2.0f * PI * innerRadius / INNER_POINTS);
    final int bands = (int) Math.round(pointAreaRadius / ds);
    final float dr = pointAreaRadius / bands;
    float r = innerRadius;
    for (int b = 0; b <= bands; b++, r += dr) {
      float circumference = 2.0f * PI * r;
      final int pointsInBand = (int) (circumference / ds);
      float eta = PI/2.0f;
      float dEta = 2.0f * PI / pointsInBand;
      for (int i = 0; i < pointsInBand; i++) {
        float x = r * FloatMath.cos(eta);
        float y = r * FloatMath.sin(eta);
        eta += dEta;
        mPointCloud.add(new Point(x, y, r));
      }
    }
  }
```

The alpha function in the foregoing example merits some further explanation. In some cases, there can be a need to support animation presented at display 4 of computing device 2. Rather than maintaining a complex data structure and modifying it for every frame in the animation, element presentation module 52 can compute alpha for one or more “contributors” using functions. In the foregoing example, there are two contributors: (1) positional glow and (2) wave alpha. It could be any number. We use the function max( ) to ensure anything with a non-zero alpha is drawn. Any function could be used in place of max( )depending on the desired effect. It could have N contributors.

In one example, the alpha function can be expressed as:

alpha=max(f(x,y),g(x,y));

where f(x,y)=positional glow contribution and g(x,y)=wave contribution.

Additionally, instead of having each dot be a function of time, in some examples, independent functions can be employed that have a scalar or position-dependent result based on a given dot “p.” In such a case, one value per function per draw can be modified and the rest can be computed in real time or substantially real time.

Since, in some cases, the foregoing functions are executed in a drawing loop associated with content presented at touch-sensitive display 4, it can need to be executed quickly. Although a brute force approach can be fast enough, in some cases, more advanced algorithms and data structures could be used to determine alpha for a given dot in the grid of dots. For example, a binary space partitioning algorithm (BSP) can be employed to avoid calling expensive functions such as pow( ) and cos( ).

In one example, element presentation module 52 calculates the wave contribution based on the distance from one of, e.g., circles 12a-12f with radius R to a given dot. We calculate the positional glow based on a function of the distance from the given dot to the position of user input reported by touch-sensitive display 4.

It is noted that f(x,y) and g(x,y) can be any arbitrary function that returns an alpha value between 0 and 1. Also, the result could be the combination of more than just two functions. We could have h(x,y), for example, which could provide an animated background value.

In one example, g(x,y) is also a function of time since the radius of the wave is a function of time. The following is an example of a function that can be used by element presentation module 52 to compute alpha for a given dot:

```
public int getAlphaForPoint(Point point) {
  // Contribution from positional glow
  float glowDistance = hypot(glowManager.x − point.x,
  glowManager.y − point.y);
  float glowAlpha = 0.0f;
  if (glowDistance < glowManager.radius) {
    float cosf = FloatMath.cos(PI * 0.25f * glowDistance /
    glowManager.radius);
    glowAlpha = glowManager.alpha * max(0.0f, (float)
    Math.pow(cosf, 10.0f));
  }
  // Compute contribution from Wave
  float radius = hypot(point.x, point.y);
  float distanceToWaveRing = (radius − waveManager.radius);
  float waveAlpha = 0.0f;
  if (distanceToWaveRing < waveManager.width * 0.5f &&
  distanceToWaveRing < 0.0f)
{
  float cosf = FloatMath.cos(PI * 0.25f * distanceToWaveRing /
  waveManager.width);
  waveAlpha = waveManager.alpha * max(0.0f, (float)
  Math.pow(cosf, 20.0f));
  }
  return (int) (max(glowAlpha, waveAlpha) * 255);
}
```

In one example, element presentation module 52 can allow both a solid circle primitive as well as a bitmap object as the item drawn at each dot. The circle primitive uses native drawing code (SKIA) to draw a geometric primitive. The bitmap object works a lot like a rubber stamp. In one example, the function can be expressed as:

```
for (p in all points) begin
    a = getAlphaForPoint(p)
    s = scaleFactor(p)
    draw bitmap (or primitive) q at position p with alpha a and scale
    factor s
end
```

The real drawing code looks like this:

```
public void draw(Canvas canvas) {
    ArrayList<Point> points = mPointCloud;
    canvas.save(Canvas.MATRIX_SAVE_FLAG);
    canvas.scale(mScale, mScale, mCenterX, mCenterY);
    for (int i = 0; i < points.size( ); i++) {
    Point point = points.get(i);
    final float pointSize = interp(MAX_POINT_SIZE,
    MIN_POINT_SIZE,
        point.radius / mOuterRadius);
    final float px = point.x + mCenterX;
    final float py = point.y + mCenterY;
    int alpha = getAlphaForPoint(point);
    if (alpha == 0) continue;
    if (mDrawable != null) {
    canvas.save(Canvas.MATRIX_SAVE_FLAG);
    final float cx = mDrawable.getIntrinsicWidth( ) * 0.5f;
    final float cy = mDrawable.getIntrinsicHeight( ) * 0.5f;
    final float s = pointSize / MAX_POINT_SIZE;
    canvas.scale(s, s, px, py);
    canvas.translate(px − cx, py − cy);
    mDrawable.setAlpha(alpha);
    mDrawable.draw(canvas);
    canvas.restore( );
    } else {
    mPaint.setAlpha(alpha);
    canvas.drawCircle(px, py, pointSize, mPaint);
    }
  }
  canvas.restore( );
}
```

Gesture determination module 54 can receive one or more indications of user inputs received at display 4 (e.g., a touch-sensitive display). Gesture determination module 54 can determine that the one or more received indications include a gesture to cause computing device 2 to activate one or more of the objects that comprise the array of objects surrounding the lock icon output at display 4. As an example, gesture determination module 54 can determine that an indication of a user input includes an indication of a touch gesture at a region of display 4 that displays one of the objects. One or more of gesture determination module 54 or display 4 can determine a region of a touch point of an input unit, e.g. the tip of a user's finger, that is in contact with display 4 (e.g., a region of pixels of display 4 that are in contact with the input unit), and can determine that a touch gesture has been received to cause computing device 2 to activate one of the objects when the region of the touch point of the input unit corresponds to a region of display 4 that displays the object (e.g., a region of pixels of display 4 that display the object).

For instance, gesture determination module 54 can determine that a touch gesture has been received to cause computing device 2 to activate the object when the overlapping region (i.e., the region of pixels of display 4 that both displays the object and is in contact with the input unit) is greater than a threshold amount, such as a threshold number of total pixels in the overlapping region (e.g., ten pixels, fifty pixels, one hundred pixels, or more pixels). The threshold number of pixels can, in certain examples, be a configurable number of pixels (e.g., user configurable using user interface 60).

In some examples, one or more of gesture determination module 54 or display 4 can determine a centroid of the region of the touch point. In such examples, gesture determination module 54 can determine that a touch gesture has been received to cause computing device 2 to activate the object when the centroid of the region of the touch point corresponds to a pixel of display 4 that displays the object. In other examples, gesture determination module 54 can determine that a touch gesture has been received to cause computing device 2 to activate the object when the centroid of the region of the touch point is within a threshold distance of a centroid of a region of display 4 that displays the objects (e.g., within a threshold number of pixels, such as five pixels, ten pixels, fifty pixels, or different numbers of pixels).

Gesture determination module 54 can determine that one or more received indications include a gesture to cause computing device 2 to select a lock icon and a number of objects in an array of objects surrounding the icon in an attempt by a user to transition computing device 2 from a locked to an unlocked state. For example, gesture determination module 54 can determine that one or more indications of user input include a swipe gesture that begins at a location of display 4 that corresponds to the location at or near which lock icon is displayed and ends at a location of display 4 that corresponds to a dot or dots arranged as the closed shape in a series of closed shapes surrounding the lock icon and that is arranged farthest away from the icon. The indications of user input interpreted by gesture determination module 54 can be part of a single continuous gesture like a swipe, or, in other examples, can include a number of separate successive user inputs like a number of taps on different locations of display 4.

Access state module 58 can determine a current access state of computing device 2. For example, access state module 58 can provide a limited access state, the limited access state configured to deny access to one or more applications executable on one or more processors 62 and information stored at one or more storage devices 64 of computing device 2. In addition, access state module 58 can provide a full access state, the access state configured to provide access to the one or more applications or information stored at one or more storage devices 64. It is noted that although the disclosed examples are described in the context of transitioning a computing device between a limited or locked access state and a full or unlocked access state, examples according to this disclosure also include transitioning between a limited access state and a different limited access state that does not provide full access to the computing device.

Access state module 58 can set the access state of computing device 2 (e.g., the limited access state or the access state) based on indications of user input received at display 4. According to the techniques of this disclosure, a user can interact with display 4 of computing device 2 to select a lock icon and a plurality of objects in an array of objects surrounding the lock icon output at display 4 in an attempt to transition computing device 2 from a locked to an unlocked state. Access state module 58 can analyze the indications of user input corresponding to the user interaction with display 4 to determine the character of the input provided by the user. In one example, access state module 58 can analyze the indications of user input corresponding to the user interaction with display 4 to determine that the user executed a swipe gesture beginning at the lock icon and ending at the closed shape in a series of closed shapes surrounding the lock icon and that is arranged farthest away from the icon. Access state module 58 can then cause computing device 2 to transition from the locked to unlocked (or other) operational state.

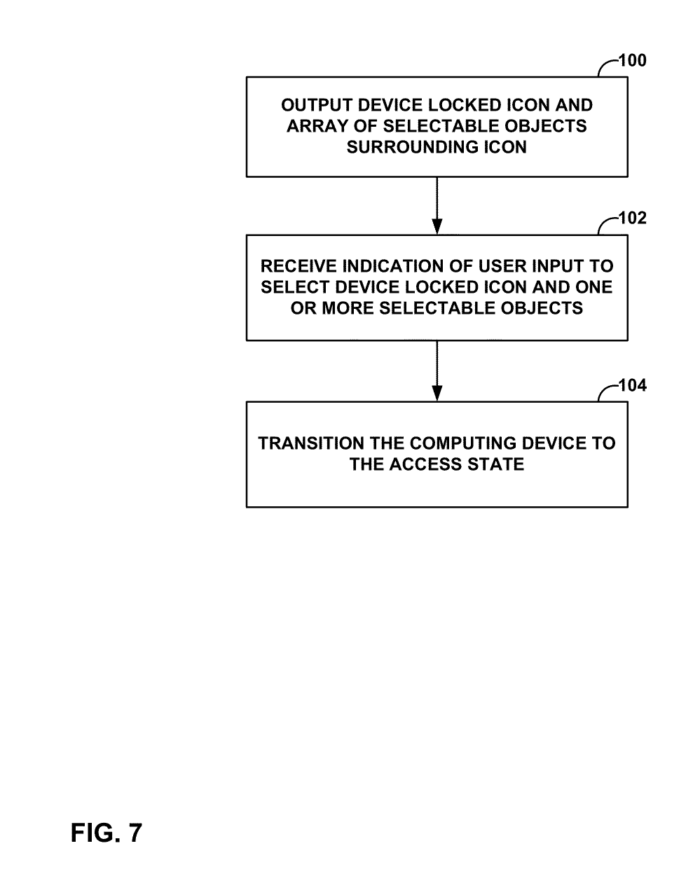

FIG. 7 is a flow chart illustrating an example operation of a computing device, in accordance with one or more aspects of this disclosure. For purposes of illustration only, the example operation is described below as carried out by various components of computing device 2 of FIGS. 1-6. However, the example method of FIG. 7 can be executed by a variety of different computing devices including a variety of physical and logical configurations.

The example method of FIG. 7 includes outputting a lock icon indicating the computing device is in a limited access state configured to deny access to one or more applications executable by the computing device and an array of objects surrounding the lock icon (100), receiving an indication of a user input received at the touch-sensitive display to select the lock icon and a plurality of the objects in the array of objects surrounding the lock icon (102), and transitioning the computing device from the limited access state to a full access state based at least in part on the indication of the user input (104).

The method of FIG. 7 includes outputting, at a touch-sensitive display operatively coupled to a computing device, a lock icon indicating the computing device is in a limited access state configured to deny access to one or more applications executable by the computing device and an array of objects surrounding the lock icon (100). In one example, computing device 2 is in a limited access state (e.g., a locked state) configured to deny access to one or more applications stored at computing device 2. Access module 6, e.g., element presentation module 52 can cause display 4 to display lock icon 10 indicating computing device 2 is in a limited access state configured to deny access to one or more applications executable by computing device 2 and an array of objects 12 surrounding the lock icon at activation area 8 of display 4.

As illustrated in FIG. 1, element presentation module 52 can cause display 4 to display lock icon 10, which includes a graphical representation of a combination padlock surrounded by a circle. Element presentation module 52 of access module 6 also causes display 4 to generate and, in some examples, display the array of objects 12, which include an array of dots arranged as a series of concentric circles 12a-12e radiating outward from the center of lock icon 10 in order of increasing diameter of each circle in the series of circles. In other examples according to this disclosure, however, the objects surrounding a lock icon can be arranged as closed shapes other than circles, including, e.g., ellipses, ovals, rectangles, squares, or other polygons, or irregular closed shapes.

The method of FIG. 7 also includes receiving, at the computing device when the computing device is in the limited access state, an indication of a user input received at the touch-sensitive display to select the lock icon and a plurality of the objects in the array of objects surrounding the lock icon (102). In one example, a user can provide a gesture at display 4 to cause computing device 2 to select lock icon 10 and some of the dots arranged as circles 12a-12f in the array of objects 12 and thereby transition computing device 2 from a locked limited access state to a full access state. Gesture determination module 54 of access module 6 can be configured to analyze one or more indications of user input received at display 4 to determine what the user input includes, e.g., to determine which areas of display 4 and which objects displayed on display 4 in such areas are activated by the user. In one example, the user gesture comprises a continuous swipe gesture beginning at lock icon 10 and ending at or near dots of circle 12f that is arranged farthest away from lock icon 10 among the series of concentric circles 12a-12f. The path of a swipe gesture can take a number of different directions and shapes, as illustrated by swipe paths 14, 16, and 22 of FIGS. 1-4C, and 5C. It should be noted that although this example is described with reference to a swipe gesture, other gestures can also be employed to unlock a computing device.

In some examples, access module 6, e.g., element presentation module 52 of access module 6 can be configured to cause display 4 to provide visual feedback to the user as the user swipes across display 4 to unlock computing device 2. For example, without any tactile input from a user activating one or more dots of circles 12a-12f, display 4 of computing device 2 can present concentric circles 12a-12f in a faded or light-colored appearance such that the circles are relatively visually deemphasized relative to other objects presented on display 4 like lock icon 10. However, upon activation of any of the circles, e.g., as the user swipes across display 4, display 4 can present a activated dot or dots, as well as, in some examples, neighboring dots or an entire circle in a non-faded or darker colored appearance such that the activated object(s) is visually emphasized relative to the other non-activated objects surrounding lock icon 10. For example, as illustrated in FIG. 3A, as the user swipes across display 4, element presentation module 52 of access module 6 causes display 4 to present activated circle 12a in a non-faded or darker colored appearance such that activated circle 12a is visually emphasized relative to the other non-activated circles 12b-12f surrounding lock icon 10.

In another example, without any tactile input from a user, element presentation module 52 of access module 6 can cause display 4 to generate the array of dots arranged as circles 12a-12f as completely transparent such that the dots are not visible to a user on display 4 of device 2. Thus, while display 4 has generated and output the array of dots arranged as concentric circles 12a-12f such that they are objects 12 on display 4 that can be activated by a user, the dots are not visible until some tactile input is received from a user at display 4. Upon activation of any of the dots, e.g., as the user swipes across presence-sensitive display 4, element presentation module 52 of access module 6 can cause display 4 to increase the opacity of the activated dot(s) and neighboring dots based on the proximity of the user input such that the affected dots appear visually to the user on display 4 in conjunction with the user input and then again disappear after the user, e.g., swipes past each dot on a path radially out from lock icon 10. For example, as illustrated in FIG. 2, as the user swipes across display 4, element presentation module 52 of access module 6 causes display 4 to present increase the opacity of activated and neighboring dots 13 such that they are visible at display 4.

The method of FIG. 7 also includes transitioning the computing device from the limited access state to a full access state based at least in part on the indication of the user input (104). In one example, after the user executes the continuous horizontal swipe gesture, e.g., as illustrated in FIGS. 1-4C, beginning near lock icon 10 and ending at or beyond the last circle 12f in the series of concentric circles 12a-12f, access module 6, e.g., access state module 58 of access module 6 can transition computing device 2 from a locked limited access state to a full access state. For example, access state module 58 can set the access state of computing device 2 (e.g., the limited access state or the access state) based on a comparison of a candidate passcode entered by a user and a predetermined passcode (e.g., a predetermined passcode stored at one or more storage devices 64).

As noted above, a user can interact with display 4 of computing device 2 to select a lock icon and a plurality of objects in an array of objects surrounding the lock icon output at display 4 in an attempt to transition computing device 2 from a locked to an unlocked state. Access state module 58 can analyze the indications of user input corresponding to the user interaction with display 4 to determine whether not to transition device 2 from one access state to another, e.g., from a locked to an unlocked state. In one example, access state module 58 can analyze the indications of user input corresponding to the user interaction with display 4 to determine that the user executed a swipe gesture beginning at the lock icon and ending at the closed shape in a series of closed shapes surrounding the lock icon and that is arranged farthest away from the icon. Access state module 58 can then compare the gesture to a predetermined gesture or data indicative of a gesture, e.g. a gesture configured by a user with access initiation module 50 and stored in storage devices 64. In the event the unlock gesture received at display 4 and the predetermined gesture match, access state module 58 can cause computing device 2 to transition from the locked to unlocked (or other) operational state.

The foregoing examples have been described in the context of transitioning a computing device from a limited access state to a different access state. However, the concept and implementation of a light field of objects generated at a touch-sensitive display of a computing device and with which a user can interact via the display can be employed in any of a number of different contexts of using a computing device. For example, after a computing device has been transitioned to an unlocked state, a light field can be employed in a variety of geometric configurations, e.g. concentric circles or a rectangular grid, to invoke one or more functions of the operating system of or a particular application executed by the computing device. For example, the computing device can cause the touch-sensitive display to generate a partially or completely transparent grid of dots on a portion of the display when in an unlocked state. In one such an example, when a user activates, e.g., a particular location on the display and then swipes across a portion or all of the grid of dots, the computing device can cause the display to increase the opacity of dots in the grid based on the proximity of the dots to the user gesture, e.g., in the manner described above with reference to FIGS. 2 and 8A-8C. Additionally, upon completion of the gesture, the computing device can invoke one or more functions, e.g. launch an operating system or third-party application on the computing device.

In another example, the light field can be employed when a mobile phone or other computing device is in a locked state and is receiving an incoming phone call. In one such example, a mobile phone can cause a touch sensitive display to display a lock icon surrounded by a field of visible or completely transparent dots forming a plurality of concentric circles similar to the examples described above. In one example, however, as the phone call is received, the dots arranged as circles pulse into and out of appearance independent of user input received at the touch-sensitive display. The pulsing appearance of the dots arranged as circles radiating out from the lock icon can serve as a visual cue to users of the manner in which to unlock the phone, e.g., what gesture can be used to unlock the phone. This visual cue of the unlock gesture can be used in other operational states of the mobile phone or other computing device. For example, a mobile phone can cause a presence-sensitive display to cause an array of dots arranged as circles to pulse into and out of appearance independent of user input received at the display whenever the display is first activated and is in a locked or other limited access state.

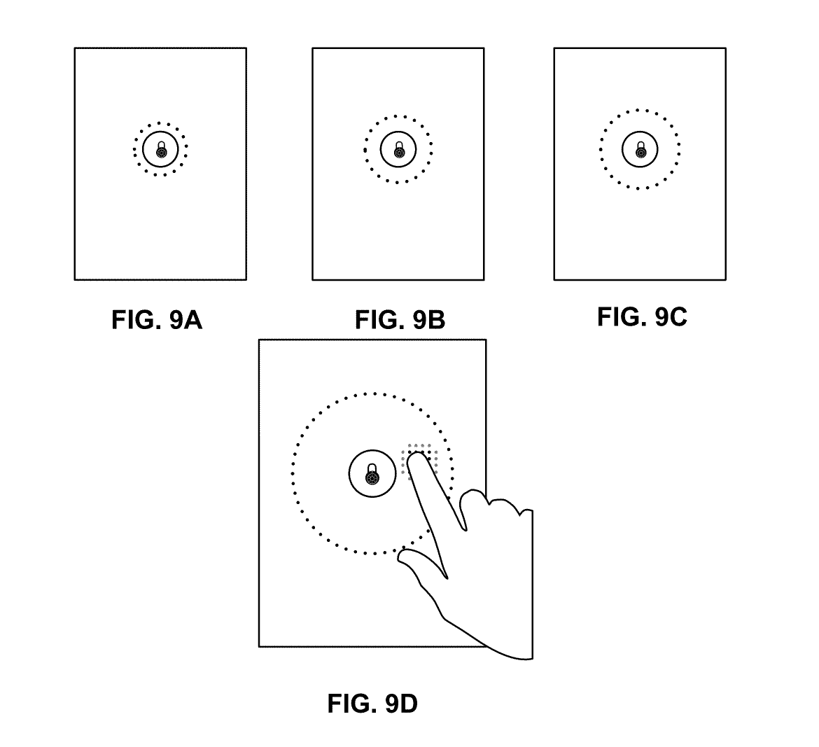

FIGS. 9A-9D illustrate a visual cue indicative of an unlock gesture necessary to unlock a computing device, in which an array of dots arranged as concentric circles surrounding a lock icon pulse into and out of appearance independent of user input received at a presence-sensitive display. FIG. 9D also illustrates a user input received at a display of a computing device and the visual feedback provided by at the display, in which activated and neighboring dots in an array of dots surrounding the lock icon appear and disappear in correspondence with the location of the indication of user input at the display of the computing device in a manner similar to that described above with reference to FIG. 2.

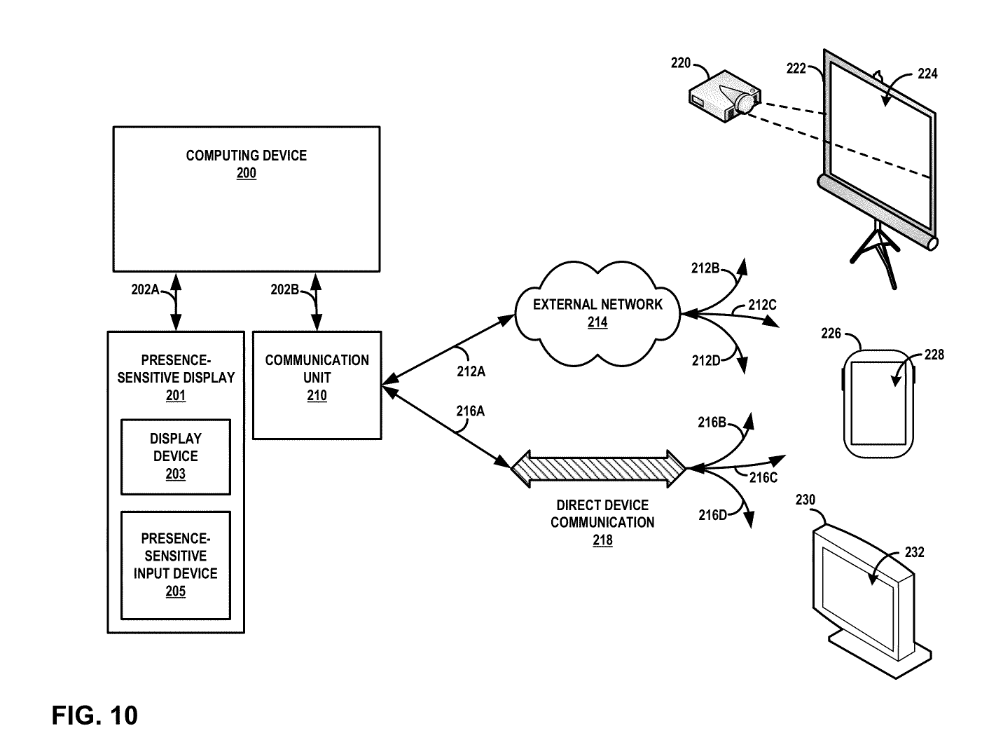

FIG. 10 is a block diagram illustrating an example computing device that outputs graphical content for display at a remote device, in accordance with one or more techniques of the present disclosure. Graphical content, generally, may include any visual information that may be output for display, such as text, images, a group of moving images, etc. The example shown in FIG. 10 includes a computing device 200, presence-sensitive display 201, communication unit 210, projector 220, projector screen 222, tablet device 226, and visual display device 230. Although shown for purposes of example in FIGS. 1 and 6 a stand-alone computing device, a computing device may, generally, be any component or system that includes a processor or other suitable computing environment for executing software instructions and, for example, need not include a presence-sensitive display.

As shown in the example of FIG. 10, computing device 200 may be a processor that includes functionality as described with respect to processor 62 in FIG. 6. In such examples, computing device 200 may be operatively coupled to presence-sensitive display 201 by a communication channel 202A, which may be a system bus or other suitable connection. Computing device 200 may also be operatively coupled to communication unit 210, further described below, by a communication channel 202B, which may also be a system bus or other suitable connection. Although shown separately as an example in FIG. 10, computing device 200 may be operatively coupled to presence-sensitive display 201 and communication unit 210 by any number of one or more communication channels.

In other examples, such as illustrated previously in FIGS. 1 and 6, computing device 200 may be a portable or mobile device such as mobile phones (including smart phones), laptop computers, etc. In some examples, computing device 200 may be a desktop computers, tablet computers, smart television platforms, cameras, personal digital assistants (PDAs), servers, mainframes, etc.

Presence-sensitive display 201, as shown in FIG. 10, may include display device 203 and presence-sensitive input device 205. Display device 203 may, for example, receive data from computing device 200 and display the graphical content. In some examples, presence-sensitive input device 205 may determine one or more user inputs (e.g., continuous gestures, multi-touch gestures, single-touch gestures, etc.) at presence-sensitive display 201 using capacitive, inductive, and/or optical recognition techniques and send indications of such user input to computing device 200 using communication channel 202A. In some examples, presence-sensitive input device 205 may be physically positioned on top of display device 203 such that, when a user positions an input unit over a graphical element displayed by display device 203, the location at which presence-sensitive input device 205 corresponds to the location of display device 203 at which the graphical element is displayed.

As shown in FIG. 10, computing device 200 may also include and/or be operatively coupled with communication unit 210. Communication unit 210 may include functionality of transceiver 68 as described in FIG. 6. Examples of communication unit 210 may include a network interface card, an Ethernet card, an optical transceiver, a radio frequency transceiver, or any other type of device that can send and receive information. Other examples of such communication units may include Bluetooth, 3G, and WiFi radios, Universal Serial Bus (USB) interfaces, etc. Computing device 200 may also include and/or be operatively coupled with one or more other devices, e.g., input devices, output devices, memory, storage devices, etc. that are not shown in FIG. 10 for purposes of brevity and illustration.

FIG. 10 also illustrates a projector 220 and projector screen 222. Other such examples of projection devices may include electronic whiteboards, holographic display devices, and any other suitable devices for displaying graphical content. Projector 220 and project screen 222 may include one or more communication units that enable the respective devices to communicate with computing device 200. In some examples, the one or more communication units may enable communication between projector 220 and projector screen 222. Projector 220 may receive data from computing device 200 that includes graphical content. Projector 220, in response to receiving the data, may project the graphical content onto projector screen 222. In some examples, projector 220 may determine one or more user inputs (e.g., continuous gestures, multi-touch gestures, single-touch gestures, etc.) at projector screen using optical recognition or other suitable techniques and send indications of such user input using one or more communication units to computing device 200.

Projector screen 222, in some examples, may include a presence-sensitive display 224. Presence-sensitive display 224 may include a subset of functionality or all of the functionality of display 4 as described in this disclosure. In some examples, presence-sensitive display 224 may include additional functionality. Projector screen 222 (e.g., an electronic whiteboard), may receive data from computing device 200 and display the graphical content. In some examples, presence-sensitive display 224 may determine one or more user inputs (e.g., continuous gestures, multi-touch gestures, single-touch gestures, etc.) at projector screen 222 using capacitive, inductive, and/or optical recognition techniques and send indications of such user input using one or more communication units to computing device 200.

FIG. 10 also illustrates tablet device 226 and visual display device 230. Tablet device 226 and visual display device 230 may each include computing and connectivity capabilities. Examples of tablet device 226 may include e-reader devices, convertible notebook devices, hybrid slate devices, etc. Examples of visual display device 230 may include televisions, computer monitors, etc. As shown in FIG. 10, tablet device 226 may include a presence-sensitive display 228. Visual display device 230 may include a presence-sensitive display 232. Presence-sensitive displays 228, 232 may include a subset of functionality or all of the functionality of display 4 as described in this disclosure. In some examples, presence-sensitive displays 228, 232 may include additional functionality. In any case, presence-sensitive display 232, for example, may receive data from computing device 200 and display the graphical content. In some examples, presence-sensitive display 232 may determine one or more user inputs (e.g., continuous gestures, multi-touch gestures, single-touch gestures, etc.) at projector screen using capacitive, inductive, and/or optical recognition techniques and send indications of such user input using one or more communication units to computing device 200.

As described above, in some examples, computing device 200 may output graphical content for display at presence-sensitive display 201 that is coupled to computing device 200 by a system bus or other suitable communication channel. Computing device 200 may also output graphical content for display at one or more remote devices, such as projector 220, projector screen 222, tablet device 226, and visual display device 230. For instance, computing device 200 may execute one or more instructions to generate and/or modify graphical content in accordance with techniques of the present disclosure. Computing device 200 may output the data that includes the graphical content to a communication unit of computing device 200, such as communication unit 210. Communication unit 210 may send the data to one or more of the remote devices, such as projector 220, projector screen 222, tablet device 226, and/or visual display device 230. In this way, computing device 200 may output the graphical content for display at one or more of the remote devices. In some examples, one or more of the remote devices may output the graphical content at a presence-sensitive display that is included in and/or operatively coupled to the respective remote devices.

In some examples, computing device 200 may not output graphical content at presence-sensitive display 201 that is operatively coupled to computing device 200. In other examples, computing device 200 may output graphical content for display at both a presence-sensitive display 201 that is coupled to computing device 200 by communication channel 202A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 200 and output for display at presence-sensitive display 201 may be different than graphical content display output for display at one or more remote devices.

Computing device 200 may send and receive data using any suitable communication techniques. For example, computing device 200 may be operatively coupled to external network 214 using network link 212A. Each of the remote devices illustrated in FIG. 10 may be operatively coupled to network external network 214 by one of respective network links 212B, 212C, and 212D. External network 214 may include network hubs, network switches, network routers, etc., that are operatively inter-coupled thereby providing for the exchange of information between computing device 200 and the remote devices illustrated in FIG. 10. In some examples, network links 212A-212D may be Ethernet, ATM or other network connections. Such connections may be wireless and/or wired connections.

In some examples, computing device 200 may be operatively coupled to one or more of the remote devices included in FIG. 6 using direct device communication 218. Direct device communication 218 may include communications through which computing device 200 sends and receives data directly with a remote device, using wired or wireless communication. That is, in some examples of direct device communication 218, data sent by computing device 200 may not be forwarded by one or more additional devices before being received at the remote device, and vice-versa. Examples of direct device communication 218 may include Bluetooth, Near-Field Communication, Universal Serial Bus, WiFi, infrared, etc. One or more of the remote devices illustrated in FIG. 10 may be operatively coupled with computing device 200 by communication links 216A-216D. In some examples, communication links 212A-212D may be connections using Bluetooth, Near-Field Communication, Universal Serial Bus, infrared, etc. Such connections may be wireless and/or wired connections.

In accordance with techniques of the disclosure, computing device 200 may output, for display (e.g., at visual display device 230), an array of object surrounding an icon that indicates a limited access state of computing device 200. Computing device 200, while in the limited access state, may receive an indication of a user input received at a presence-sensitive input device (e.g., presence-sensitive input device 205, presence-sensitive displays 228, 232, etc.), the user input to activate a plurality of objects in the array of object surrounding the lock icon. Responsive to the indication of the user input, computing device 200 may transition from the limited access state to an access state.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), central processing units (CPUs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various aspects have been described in this disclosure. These and other aspects are within the scope of the following claims.

1. A method comprising:
outputting, for display, an array of objects surrounding an icon, wherein the icon indicates a limited access state of the computing device;
receiving, at the computing device while the computing device is in the limited access state, an indication of a user input detected at a location of a presence-sensitive input device, wherein a portion of the array of objects is within a threshold distance of the location; and
responsive to receiving the indication of the user input:
activating, by the computing device, the portion of the array of objects within the threshold distance of the location; and
transitioning, by the computing device, from the limited access state to an access state.

2. The method of claim 1, wherein activating the portion of the array of objects comprises:
altering, at a display device operatively coupled to the computing device, an appearance of the portion of the array of objects to indicate activation of the portion of the array of objects by the user.

3. The method of claim 2, wherein altering, at the display device operatively coupled to the computing device, an appearance of the portion of the array of objects to indicate activation of the portion of the array of objects by the user comprises changing a transparency of the portion of the array of objects to indicate activation of the portion of the array of objects by the user.

4. The method of claim 1, wherein the array of objects surrounding the icon comprises a plurality of dots arranged as a series of concentric closed shapes radiating outward from a center of the icon in order of increasing distance from the center of the icon to a perimeter of each closed shape in the series of closed shapes.

5. The method of claim 4, wherein the series of concentric closed shapes comprises a series of concentric circles radiating outward from a center of the icon in order of increasing diameter of each circle in the series of circles.

6. The method of claim 5, wherein each dot of the plurality of dots comprises one object in the array of objects.

7. The method of claim 5, wherein each circle of the series of concentric circles comprises one object in the array of objects.

8. The method of claim 4, wherein receiving, at the computing device while the computing device is in the limited access state, the indication of the user input comprises:
receiving, at the computing device while the computing device is in the limited access state, an indication of a first user input detected at the location of the presence-sensitive input device, the user input to select the icon; and
receiving, at the computing device while the computing device is in the limited access state, a series of indications of a series of additional user inputs detected at the presence-sensitive input device, the additional user inputs to activate at least one dot in each closed shape in the series of closed shapes after selecting the icon.

9. The method of claim 8, wherein the first user input and the series of additional user inputs comprise a tactile user input detected at the presence-sensitive input device, the tactile user input comprising a continuous swipe gesture beginning at the icon and ending at or beyond the closed shape in the series of closed shapes that is arranged farthest away from the icon.

10. The method of claim 4, wherein the series of concentric closed shapes comprises at least one of a series of ellipses, ovals, rectangles, squares, polygons, or irregular closed shapes radiating outward from a center of the icon.

11. A computing device, comprising:
one or more processors; and
a presence-sensitive input device,
wherein the one or more processors are operable to:
output, for display, an array of objects surrounding an icon, wherein the icon indicates a limited access state of the computing device;
receive, at the computing device when the computing device is in the limited access state, an indication of a user input detected at a location of a presence-sensitive input device, wherein a portion of the array of objects is within a threshold distance of the location; and
respond to receiving the indication of the user input:
activate the portion of the array of objects within the threshold distance of the location; and
transition the computing device from the limited access state to an access state.

12. The device of claim 11, further comprising:
a display device operatively coupled to the one or more processors,
wherein the one or more processors are operable to:
alter, at the display device, an appearance of the portion of the array of objects to indicate activation of the portion of the array of objects by the user.

13. The device of claim 12, wherein the one or more processors are operable to alter, at the display device, the appearance of the portion of the array of objects at least by changing a transparency of the portion of the array of objects to indicate activation of the portion of the array of objects by the user.

14. The device of claim 11, wherein the array of objects surrounding the icon comprises a plurality of dots arranged as a series of concentric closed shapes radiating outward from a center of the icon in order of increasing distance from the center of the icon to a perimeter of each closed shape in the series of closed shapes.

15. The device of claim 14, wherein the series of concentric closed shapes comprises a series of concentric circles radiating outward from a center of the icon in order of increasing diameter of each circle in the series of circles.

16. The device of claim 15, wherein each dot of the plurality of dots comprises one object in the array of objects.

17. The device of claim 15, wherein each circle of the series of concentric circles comprises one object in the array of objects.

18. The device of claim 14, wherein the one or more processors are operable to receive, at the computing device when the computing device is in the limited access state, the indication of the user input at least by:
receiving, at the computing device when the computing device is in the limited access state, an indication of a first user input detected at the location of the presence-sensitive input device, the first user input to select the icon; and
receiving, at the computing device when the computing device is in the limited access state, a series of indications of a series of additional user inputs detected at the presence-sensitive input device, the additional user inputs to activate at least one dot in each closed shape in the series of closed shapes after selecting the icon.

19. The device of claim 18, wherein the first user input and the series of additional user inputs comprise a tactile user input detected at the location of the presence-sensitive input device, the tactile user input comprising a continuous swipe gesture beginning at the icon and ending at or beyond the closed shape in the series of closed shapes that is arranged farthest away from the icon.

20. The device of claim 14, wherein the series of concentric closed shapes comprises at least one of a series of ellipses, ovals, rectangles, squares, polygons, or irregular closed shapes radiating outward from a center of the icon.

21. A computer-readable storage medium comprising instructions that, if executed by a computing device having one or more processors operatively coupled to a presence-sensitive display, cause the computing device to perform operations comprising:
outputting, for display, an array of objects surrounding an icon, wherein the icon indicates a limited access state of the computing device;
receiving, at the computing device when the computing device is in the limited access state, an indication of a user input detected at a location of a presence-sensitive input device, wherein a portion of the array of objects is within a threshold distance of the location; and
responsive to receiving the indication of the user input:
activating the portion of the array of objects within the threshold distance of the location; and
transitioning, by the computing device, from the limited access state to an access state.
